(19) United States
(12) Patent Application Publication
(10) Pub. No.: US 2002/0101969 A1
(43) Pub. Date: Aug. 1, 2002

(54) Prepaid calling card system

(76) Inventor: Ruth-Ellen Beebe, Harvard, ID (US)

Correspondence Address: Greenberg and Lieberman, 314 Philadelphia Avenue, Takoma Park, MD, 20912, US

(21) Appl. No.: 09/769,340

(22) Filed: Jan. 26, 2001

(51) Int. Cl. H04M 15/00; H04M 17/00

(52) U.S. Cl. 379/144.01; 379/114.25

(57) ABSTRACT

The present invention is a pre-paid calling card system for companies that utilize 900 lines. The cards are graphically designed to imbibe the nature of the particular 900 number. The cards are targeted for specific 900 numbers and are easily be marketed along side products that are similar to the 900 line. The cards provide a method for a caller to know exactly the amount spent on calls in advance as they are pre-paid. The present invention allows callers to dial 900 numbers from any location with a phone without worries of surcharges or reverse billing. The callers are assured anonymity in their calls due to the nature of pre-paid calling cards.

### FIELD OF THE INVENTION

The present invention is a prepaid calling card system, more specifically a calling card system for 900 numbers.

### BACKGROUND OF THE INVENTION

Pre-Paid calling cards are sold in many convenient venues in the United States, such as gas stations and grocery stores. Pre-paid calling cards are simple to use and are gaining popularity, for home office and mobile use. They create an easy medium for people to contact those not in their area and still keep to a budget, because they are pre-paid. However pre-paid calling cards cannot yet be used for 900 numbers which charge high per minute rates, as most prepaid cards allow the user so many minutes at a per minute rate lower than most 900 numbers.

900 numbers are also growing in popularity. These charge calls offer a variety of services, from game tips from companies such as Nintendo TM, psychic readings, and adult entertainment. An inherent problem with 900 numbers are the sometimes astronomical bills incurred from the confusing per minute charges. Also privacy is a large issue to many people who call these lines, and then find that they receive related mailings to the type of number that they called, and offers for other numbers of that nature. Additionally, any one who has access to the phone bill of the caller knows which lines were called, and further invades the person's privacy, and 900 calls must be billed to the number they are received from, thereby making remote billing impossible.

U.S. Pat. No. 6,111,940 issued to Kugell, on Aug. 29, 2000, exhibits a method for providing telephonic services. Kugell's invention is unlike the present invention because it is not a pre-paid calling card system, it is not designed for 900 numbers in particular, it requires a call back to the number that the user calls from, and does not provide anonymity to the customer because of the call back function to the originating number.

U.S. Pat. No. 5,970,133 issued to Salimando, on Oct. 19, 1999, exhibits a call branding system. Salimando's invention is unlike the present invention because, it is not a pre-paid calling system, it is not designed specifically for 900 numbers, it displays the name associated with the number that is being called for mass calling purposes, and therefore gives no anonymity to the person being called or using the services offered.

U.S. Pat. No. 5,749,075 issued to Toader, et al., on May 5, 1998 exhibits a method for providing prepaid Internet access and/or long distance calling including the distribution of specialized calling cards. Toader's invention is unlike the present invention because it is intended for Internet access and long distance calls only, and not 900 numbers, it does not provide the user with anonymity of the present invention, and requires an extra step of registering and waiting for Internet software which requires the user to supply address information to receive the software.

U.S. Pat. No. 5,003,584 issued to Benyacar, et al.,on Mar. 26, 1991 exhibits a method and apparatus for the billing of value added communication calls. Benyacar's invention is unlike the present invention because it is a method for billing calls in a real time fashion from residences or businesses to the provider, is not a pre-paid calling card system, does not provide the caller with anonymity, and is not specifically for 900 numbers.

Additionally, MCI offers calling cards through their World Com service as exhibited on their web page, http://www.mei.com/international/english/wp_callingcard.shtml . MCI's calling card is unlike the present invention because 900 numbers cannot be billed from overseas locations, and the customer is not offered anonymity as with a pre-paid calling card.

Therefore a need has been established for a pre-paid calling card system directed specifically for 900 numbers, that can be used from any phone and allow anonymity for the caller.

### SUMMARY OF THE INVENTION

The present invention is a pre-paid calling card system for companies that utilize 900 lines. The cards can be graphically designed to imbibe the nature of the particular 900 number. For example, cards issued for a particular psychic line could show the logo of that line, or a picture of the featured psychic. The cards are targeted for specific 900 numbers and can easily be marketed along side products that are similar to the 900 line. For example, the cards targeted to adult lines could be marketed in adult stores.

An advantage to pre-paid calling cards for 900 numbers is that the caller has total anonymity in their calling habits. The cards create a system where a caller may call a 900 number from any location with a phone, and not worry about billing to that number. The present invention also allows the caller to know exactly how much they have spent on the calls, and alleviates the shock from high phone bills. Also, the 900 lines will have a broadened customer base, because many consumers do not call 900 lines for the worry of the phone bills associated with calls of this nature. However if the consumer knows up front what they are spending they are more likely to take advantage of these services.

A caller may use the present invention from any phone anonymously. They can be assured that their privacy is protected, and that they may call from any location. For example, if a caller wanted to call a 900 number from a hotel room, they would be charged a fee for making a long distance call, a per minute charge from the 900 company, and additional charges from the hotel.

Also if a caller wishes to call from their residence the calls will not be billed to their phone bill. In that manner, their confidentiality is protected, because if another person sees the phone bill they will not know about 900 calls made from that line.

Pre paid calling cards for 900 number services, will only be purchased through adult channels much the same as cigarettes, liquor and other adult materials. This will help to keep these 900 services out of the hands of minors. The present invention will soon be available to the providers of these services, it is possible that the federal government may intervene and force the adult services to use this new method of marketing for the express purpose of keeping these adult services out of the reach of children or minors. These cards will give the providers of these adult services a means to more carefully monitor the age of their customers, as well as give the government a means to control the age group of the consumers of this adult market.

### DETAILED DESCRIPTION OF THE PREFERRED EMBODIMENT(S)

The present invention is a method for pre-paid calling cards specifically for 900 numbers. Many companies offer 900 numbers for support for their products and tips on better ways to use those products. There are also 900 numbers for services such as psychic readings and adult lines. 900 numbers bill at a rate higher than regular long distance calls and many callers are reluctant to call 900 lines for that reason. Since many services offered by 900 numbers are private in nature, i. e. adult lines, callers often are reluctant to call for privacy reasons as the calls are itemized on their phone bills for anyone to see.

The present invention is a pre-paid calling card in specific denominations targeted for specific 900 numbers. For example, the denominations offered could be $25, $50, or $100, or in denominations of minutes, 20 minutes, 40 minutes, 1 hour or more. The cards would be offered as a service to the providers of the 900 numbers, and would be designed graphically to match the type of 900 number that was being marketed. The cards could carry the logo of the number with which they are associated, advertisements for associated websites, or pictures representative of the services offered.

Companies that offer 900 numbers can market the cards in the same venues as their existent products. For example, the pre-paid calling cards associated with gaming systems could be sold in the retailers that carry the games, in game rental agencies, and in stores that offer the game systems, i.e. NINTENDO, PLAY STATION, or DREAMCAST. Pre-Paid cards associated with adult services can be marketed through adult book and video stores, and where adult periodicals are sold.

An inherent advantage to the callers using these cards is that they are assured that they will not spend above a certain amount on the calls. The cards when exhausted are deactivated, and the caller knows up front what they are spending on the calls. There is no later shock of a high telephone bill, because of a misunderstanding of the fees involved in the per minute charges. The caller has a limited amount of money or minutes associated with each card, and can only use that amount of money or minutes for their calls.

Privacy concerns are also addressed by the present invention, because the cards make the calls to 900 numbers anonymous for the caller. The callers do not have the problem of the 900 numbers being itemized on their telephone bill. The callers may use the pre-paid cards from any telephone, either at their residence, a hotel room or any location with a telephone. The cards can also be programmed for rates from international destinations, so callers may use them while on travel outside of the United States.

The present invention will allow the caller to dial a toll free number and enter a code in order to be connected to the appropriate 900 number. In this manner children could not use the game calling cards to call adult lines because the code would be separate from that of the game card. The anonymity of the calls made from the calling cards will allow a broadening of the market for many callers who have been reluctant to call 900 numbers due to worries about releasing the number from which they are calling to the 900 numbers, via Caller ID or other such systems. They can also be assured that the calls will not show up on their telephone bill for anyone to see.

It is to be understood that the present invention is not limited to the embodiments listed above but encompasses any and all of the embodiments in the following claims.

I claim:

1. A method for allowing individuals to access 900 numbers, comprising:
a pre-paid calling card; and
a personal identification number associated with each card.

2. A method as in claim 1, wherein said pre-paid calling card is connected to a singular 900 number.

3. A method as in claim 1, wherein said pre-paid calling card is available in different monetary denominations.

4. A method as in claim 1, wherein said pre-paid calling card is available for sale through adult venues only.

5. A method as in claim 1, wherein said pre-paid calling card is anonymous to the user.

6. A method as in claim 1, wherein said personal identification number is required for activation of said pre-paid calling card.

7. A method as in claim 1, wherein said pre-paid calling cards are used for psychic 900 lines.

8. A method as in claim 1, wherein said pre-paid calling card are used for adult 900 lines.

9. A method as in claim 1, wherein said pre-paid calling cards are used for gaming 900 lines.

10. A method as in claim 1, wherein said pre-paid calling cards are used for customer support 900 lines.

11. A method for restricting use of 900 numbers, comprising:
electronically coding magnetic tape on a card;
assigning a value to the card such that the value is equivalent to a specific code on the card; and
distributing said cards to businesses that operate 900 numbers.

12. A method for restricting use of 900 numbers, comprising:
assigning specific codes to cards, wherein each code will expire upon monetary depletion;
distributing said cards to businesses with 900 numbers;
receiving calls to the 900 number associated with said code on said card; and
disconnecting said calls when said code has expired.
